(19) United States
(12) Patent Application Publication
(10) Pub. No.: US 2023/0219384 A1
(43) Pub. Date: Jul. 13, 2023

(54) Tire Lever Adapter

(71) Applicant: The Bike Hangar LLC, Shreveport, LA (US)

(72) Inventor: John Squires SMITH, Shreveport, LA (US)

(21) Appl. No.: 18/095,397

(22) Filed: Jan. 10, 2023

Related U.S. Application Data
(60) Provisional application No. 63/297,903, filed on Jan. 10, 2022.

(51) Int. Cl. B60C 25/02

(52) U.S. Cl. CPC B60C 25/02

(57) ABSTRACT

A tire lever head physically adapted to couple to an end of a 16-gram or 25-gram CO₂ cartridge, but to not pierce the CO₂ cartridge. Rather than using the CO₂ cartridge for its nominally intended purpose of inflating a tire or tube, the tire-lever head functions as the handle portion of a tire lever. That is, the CO₂ cartridge is gripped by a user, and is manipulated to apply the force that is required for tire removal/installation.

### STATEMENT OF RELATED CASES

This specification claims priority of U.S. 63/297,903, filed Jan. 10, 2022, which is incorporated herein by reference.

### FIELD OF INVENTION

The present invention relates to a device for use when changing, replacing, or repairing a bicycle tire or tube.

### BACKGROUND

A tire lever is used to remove tires from, or install them on, the wheel of a bicycle. Typically embodied as a singular piece of a hard plastic and/or steel, a tire lever has a length of about three to five inches. The tire lever has a handle or body portion that accounts for most of its length, and a tapered/contoured end, which bends out of the plane from the body.

In use, the tapered end of the tire lever is slipped between the “lip” of the tire and the rim of the wheel. To facilitate that, the tapered end progressively decreases in thickness. In some versions, the tapered end has a curved profile. The relatively thicker and longer handle portion provides the strength and leverage required for tire removal or installation without snapping the tire lever. Many tire levers have a small hook on the other end of the lever so that it can be secured to one of the spokes of the wheel (while a second tire lever is being used).

Hard plastic levers are often sold in sets of two or three, and may be categorized as “portable levers.” They are designed to be light weight and easy to stow on a bicycle during a ride. These levers are usually designed to snap together for compact storage. Such levers are often packaged and stored in combination with a “flat-tire repair kit,” which usually includes a multi-tool, compact pump or CO₂ cartridge and inflator head, and an extra tire tube.

Steel levers, or plastic levers with a steel core, are similar in design to the hard plastic lever, but they are more robust. Such tire levers may be categorized as a “shop lever,” as they are often used in bicycle shops where they will see more frequent use than a portable lever, and are better suited for prying difficult to remove tires from a bicycle wheel.

Although most consumer tire levers are of proper size to fit in the pocket of a cycling jersey or a saddle bag, they are still among the largest items carried on a ride.

### SUMMARY

The present invention provides a bicycle tire maintenance tool —referred to hereinafter as a “tire lever head″— that avoids some of the inconveniences and disadvantages of the prior art. A tire lever head in accordance with the invention is tapered and contoured similarly to the tapered end of a conventional tire lever. But the tire lever head is not a singular part capable of providing the leverage necessary to install or remove a tire on its own. Rather, the tire lever head couples to a CO₂ cartridge for use in removing/installing a tire.

Familiar to cyclists, CO₂ cartridges are commonly used as an alternative to a pump for rapidly inflating a tire. The cartridge, which contains compressed CO₂ and is typically available in 16-gram or 25-gram versions, is conventionally used in conjunction with an inflator head. The inflator head receives the narrowed end of the CO₂ cartridge (either via a screw fit or a press fit), and attaches to the valve stem of the tire to dispense the CO₂, thereby inflating the tire. (https://www.genuineinnovations.com/blogs/learn-about-our-tech/everything-you-need-to-know-about-co2-inflation-for-bike-tires.)

The tire lever head disclosed herein is thus an adapter that removably couples to a CO₂ cartridge in a manner similar to how a conventional inflator head couples to such a cartridge. Unlike an inflator head though, the tire lever head does not pierce the cartridge (which would, after removal of the tire lever head, undesirably enable CO₂ to flow from the cartridge). So rather than using the CO₂ cartridge for its nominally intended purpose of inflating a tire or tube, the cartridge functions as the handle portion of a tire lever. That is, the CO₂ cartridge is gripped by a user, and is manipulated to apply the force that is required for tire removal/installation.

After a bicycle tire is removed and a new tube is inserted, the tire lever head can be removed from the CO₂ cartridge and replaced by a conventional inflator head. With an inflator installed, the CO₂ cartridge can then be used for its nominal purpose of inflating the tube/tire. Of course, the tire lever head can be installed on a spent CO₂ cartridge as well. Thus, the tire lever head creates a second use for the CO₂ cartridge. But more importantly, embodiments of the present invention provide a tool that is capable of serving the purpose of a traditional tire lever while being smaller in size than such levers. In particular, in some embodiments, the tire lever head has a length of about 1.5 inches.

### BRIEF DESCRIPTION OF THE DRAWINGS

FIG. 1A depicts a CO₂ cartridge attached to a tire lever head in accordance with the illustrative embodiment of the present invention. The figure depicts the tire lever head in use and oriented to remove the tire from the rim of the wheel.

FIG. 1B depicts the CO₂ cartridge and attached tire lever head of FIG. 1 in use, but oriented to install a tire on the rim of the wheel.

FIG. 2A depicts a three-quarters perspective view of a CO₂ cartridge connected to the tire lever head in accordance with the present teachings.

FIG. 2B depicts a side view of a CO₂ cartridge connected to a tire lever head.

FIG. 3A depicts a tire lever head in accordance with the present invention.

FIG. 3B depicts a view of the back of the tire lever head.

FIG. 3C depicts a conventional threaded CO₂ cartridge.

### DETAILED DESCRIPTION

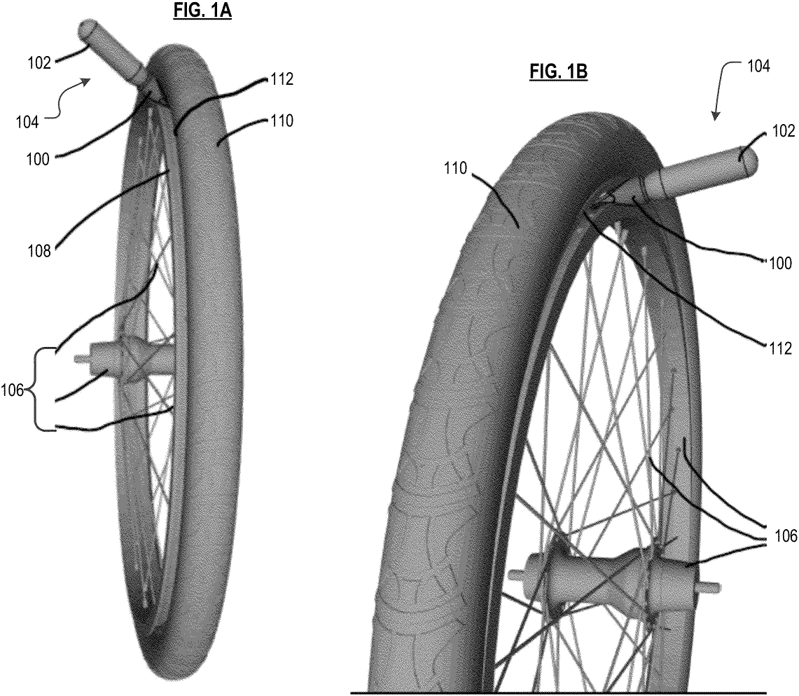

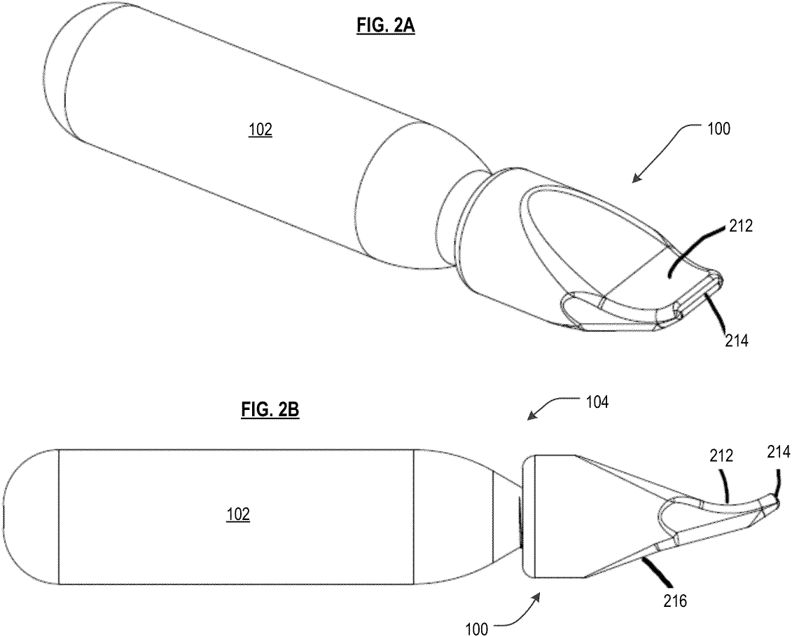

FIG. 1A depicts tire lever head 100 coupled to conventional CO₂ cartridge 102, forming cartridge-based tire lever 104. Tire lever head 100 is positioned between bead/lip 112 of tire 110 and rim 108 of wheel 106 (the wheel including a hub, spokes, and rim 108). In FIG. 1A, tire lever head 100 is oriented for removing tire 110 from rim 108. For tire removal, curved surface 212 (FIGS. 2A/2B) of tire lever head 100 is in an upward/outward facing orientation. Attached as it is to tire lever head 100, CO₂ cartridge 102 serves as a handle for cartridge-based tire lever 104. CO₂ cartridge 102 thus enables a user to manipulate tire lever head 100, such as to force it between rim 108 and tire 110, and to apply the requisite force to decouple the two.

FIG. 1B depicts cartridge-based tire lever 104 oriented for installing tire 110 on rim 108 of wheel 106. For tire installation, curved surface 212 of tire lever head 100 is in a downward/inward facing orientation, whereas flat surface 216 (FIG. 2B) of tire lever head 100 faces upward/outward. In this orientation, and when in use, curved surface 212 stays in contact with rim 108. With flat side 216 facing upward/outward, the flat side tapers downwardly towards tip 214. This enables lip/bead 112 of tire 110 to slide off flat side 216 and onto rim 108 of wheel 106.

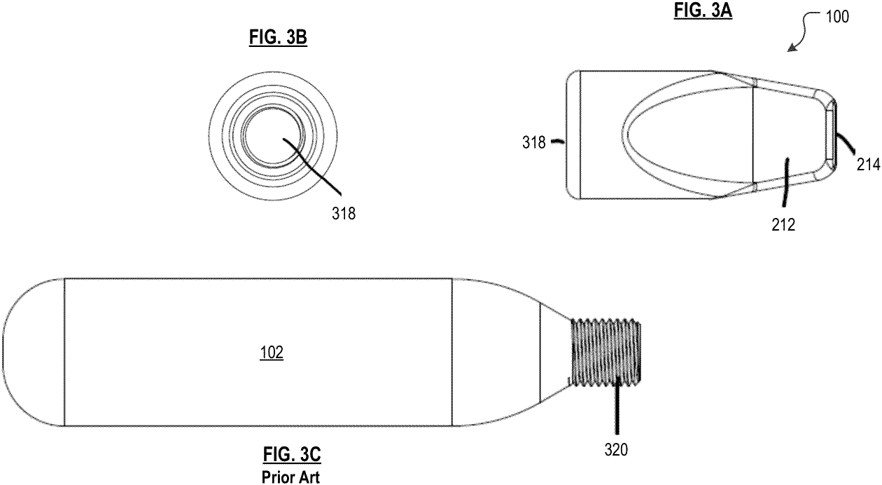

FIGS. 2A and 2B depict respective three-quarters perspective and side views of cartridge-based tire lever 104. Tire lever head 100 removably couples to CO₂ cartridge 102. FIG. 3A depicts tire lever head 100 in an uncoupled state. Cavity 318 of tire lever head 100, depicted end-on in FIG. 3B, receives narrowed end 320 of CO₂ cartridge 102, depicted in FIG. 3C. As previously noted, one surface of tire lever head 100 includes curved surface 212, whereas a surface on the opposite side of the tire lever head includes flat surface 216.

The nature of the coupling between tire level head 100 and CO₂ cartridge 102 is a function of the design of the CO₂ cartridge. In some embodiments, the narrowed end of CO₂ cartridge 102 is threaded (see FIG. 3C). The thread on a 16-gram or 25-gram CO₂ cartridge as used for inflating bicycle tires is ⅜ inch - 24 UNF (Unified National Fine Thread): major diameter of 0.375 inches (9.525 mm), 24 TPI (threads per inch), and 1.058 mm pitch. In such embodiments, tire lever head 100 must have corresponding internal female threads to securely engage the CO₂ cartridge. The internal threads can be provided as an internally threaded insert, such as a brass insert, which is received in cavity 318 of the tire lever head. Alternatively, the threads can be formed directly on the surface of cavity 318.

The length of the narrow, threaded end of the CO₂ cartridge is 0.436″. The depth of cavity 318 is slightly greater than that, such as between 0.484 and 0.5 inches. The diameter of the CO₂ cartridge increases with distance from the threaded end until it reaches a maximum diameter, but readily exceeds the diameter of the perimeter of cavity 318. Therefore, when the cartridge is fully threaded into tire lever head 100, the tire level head tightens against the CO₂ cartridge, making for a secure fit.

In some other embodiments, the CO₂ cartridge does not have a threaded end, and for such embodiments, tire lever head 100 does not include threads; rather, the cartridge and tire lever head engage via a press fit. Once again, the increasing diameter of the CO₂ cartridge creates a snug fit between cavity 318 and the unthreaded CO₂ cartridge. Thus, there are two versions of tire lever head 100; one that is internally threaded, and one version that is not threaded.

Some embodiments of the invention provide a kit, which includes plural CO₂ cartridges and plural tire lever heads. Generally, but not necessarily, two tire levers are used for tire removal. This is true whether the tire levers are conventional, or the cartridge-based levers in accordance with the invention. Consequently, kits in accordance with the invention preferably, but not necessarily, include at least two tire lever heads, and at least two CO₂ cartridges. In some embodiments, the kit also includes an inflator head. In some further embodiments, the kit also includes a tire tube. And in some further embodiments, the kit includes, in addition to any or all of the foregoing items, a multi-tool.

What is claimed:

1. An article comprising a tire lever head, the tire lever head physically adapted to couple to an end of a 16-gram or 25-gram CO₂ cartridge, but to not pierce the CO₂ cartridge, the tire lever head including:
a first end, the first end physically adapted to receive the CO₂ cartridge, wherein the first end of the tire lever head has a first thickness;
a second end, the second end of the tire lever head having a second thickness, wherein the second thickness is less than the first thickness;
a first surface disposed between the first end and the second end, wherein the first surface is curved; and
a second surface disposed between the first end and the second end, wherein the first surface is flat, wherein the first surface and the second surface are disposed on opposite sides of the tire lever head.

2. The article of claim 1 comprising the CO₂ cartridge, the tire lever head including a cavity accessible from the first end of the tire lever head, wherein a narrowed end of the CO₂ cartridge is received by the cavity of the tire lever head.

3. The article of claim 2 wherein the cavity includes a plurality of female threads sized to engage threads disposed on the narrowed end of the CO₂ cartridge.

4. The article of claim 1 wherein the tire lever head includes a cavity accessible from the first end of the tire lever head.

5. The article of claim 4 wherein the cavity includes a plurality of female threads sized to engage an externally threaded narrowed end of the CO₂ cartridge.

6. The article of claim 4 wherein the cavity receives a threaded insert sized to engage a ⅜ inch -24 TPI externally threaded narrowed end of the CO₂ cartridge.

7. The tire lever head of claim 2 wherein a depth of the cavity is greater than a length of the narrowed end of the CO₂ cartridge.

8. The tire lever head of claim 4 wherein a depth of the cavity is greater than a length of a narrowed end of the CO₂ cartridge.

9. The tire lever head of claim 1 wherein the tire lever head has a length of about 1.5 inches or less.

10. A kit comprising:
a CO₂ cartridge, the CO₂ cartridge having a narrowed end; and
a tire lever head, wherein the tire lever head has a first end that is physically adapted to couple to the narrowed end of the CO₂ cartridge, but to not pierce the CO₂ cartridge.

11. The kit of claim 10 comprising an inflator head, wherein the inflator head is physically adapted to couple to the narrowed end of the CO₂ cartridge and pierce the CO₂ cartridge.

12. The kit of claim 11 comprising a tire tube.

13. The kit of claim 12 including a multi-tool.

14. The kit of claim 10 wherein the tire lever head includes a cavity accessible from the first end of the tire lever head, wherein the narrowed end of the CO₂ cartridge is received by the cavity of the tire lever head.

15. The kit of claim 14 wherein the cavity includes a plurality of female threads sized to engage threads disposed on the narrowed end of the CO₂ cartridge.

16. The kit of claim 14 wherein the cavity receives a threaded insert sized to engage ⅜ inch -24 TPI threads on the narrowed end of the CO₂ cartridge.

17. The kit of claim 14 wherein a depth of the cavity is greater than a length of the narrowed end of the CO₂ cartridge.
